(19) United States
(12) Patent Application Publication
(10) Pub. No.: US 2014/0224341 A1
(43) Pub. Date: Aug. 14, 2014

(54) METHOD AND SYSTEM FOR IDENTIFYING LEAKS IN GAS PIPE CONSTRUCTION

(71) Applicant: Dov Barkay, Ramat Ishay (IL)

(72) Inventor: Dov Barkay, Ramat Ishay (IL)

(73) Assignee: NLEAK, LTD., Binyamina (IL)

(21) Appl. No.: 14/118,418

(22) PCT Filed: May 16, 2012
(86) PCT No.: PCT/IL2012/000191

§ 371 Date: Apr. 11, 2014

Related U.S. Application Data
(60) Provisional application No. 61/486,445, filed on May 16, 2011.

(51) Int. Cl. G05D 7/06; G01M 3/04

(52) U.S. Cl. CPC G05D 7/0629; G01M 3/04
USPC 137/2; 137/487.5

(57) ABSTRACT

The present invention provides a system for identifying gas leaks in pipe construction. The system is comprised of: a gas detection unit including a odor sensor and a wireless communication unit, said detection unit is positioned in proximity of at least one gas entrance/supply of said pipe construction, and a controlled shutoff unit including a valve an actuator unit and wireless communication unit. The shutoff unit integrated with interface entrance unit of the pipe construction and the actuator unit arranged to control the valve. Upon detection of odor measurement exceeding predefined level the actuator unit is activated to close the valve.

### TECHNICAL FIELD

The present invention relates to the field of identification of gas leaks in pipes construction and more specifically to identification of leak by odor sensors.

### BACKGROUND

The known systems in the art for detecting gas leak require wired communication which is integrated in the infrastructure of pipe construction. Such system can't be implemented in gas construction of domestic use. Accordingly there is a need for gas detection system which can be integrated with existing domestic gas infrastructure.

### BRIEF SUMMARY

The present invention provides a system for identifying gas leaks in pipe construction. The system is comprised of: a gas detection unit including a odor sensor and a wireless communication unit, said detection unit is positioned in proximity of at least one gas entrance/supply of said pipe construction, and a controlled shutoff unit including a valve an actuator unit and wireless communication unit. The shutoff unit integrated with interface entrance unit of the pipe construction and the actuator unit arranged to control the valve. Upon detection of odor measurement exceeding predefined level the actuator unit is activated to close the valve.

According to some embodiments of the present invention the detection unit further a micro processor which includes algorithm for determining gas level.

According to some embodiments of the present invention the detection unit further a test module for testing the sensor operation.

According to some embodiments of the present invention the detection unit further a buzzer alarm module enabling to activate sound alarm incase the gas concentration is the air has exceeded predefined level.

According to some embodiments of the present invention the shutoff unit further comprises a PCB unit for receiving the detection signals from the detection unit and controlling the actuating unit.

According to some embodiments of the present invention the shutoff unit further comprises a disk connected to the valve and associated with a spring, wherein upon activation of the actuating unit the spring is released, changing the valve position through the disk motion to close position.

According to some embodiments of the present invention the valve can be controlled manually by a button.

According to some embodiments of the present invention the detection unit further comprises a Seismometer, wherein upon detecting seismic waves which exceeds predefined level a signal is sent to the shut of unit for closing the valve.

According to some embodiments of the present invention the system further comprising an operating unit for coordinating plurality of detection devices and relay close instruction to the respective shutoff valve unit.

According to some embodiments of the present invention the system includes plurality of shutoff valves and the operating unit coordinate the operations of the plurality of shutoff valve units.

The present invention provides a method for identifying gas leaks in pipe construction using a detection unit and shutoff unit, wherein the detection units includes an odor sensor and the shutoff unit include an actuating unit and a valve, said method comprises the steps of:
measuring odor in proximity of at least one gas entrance/supply of said pipe construction by the odor sensor;
checking odor measurement level;
transmitting closure instruction to a shutoff unit in case the odor measurement exceeded predefined level;
activating the actuator unit upon receiving the closure instruction, wherein the actuating device motion close the valve.

According to some embodiments of the present invention the method further comprising the step of testing the sensor operation.

According to some embodiments of the present invention the method further comprising the step activating sound alarm incase the gas concentration is the air has exceeded predefined level.

According to some embodiments of the present invention the shutoff unit further comprises a disk connected to the valve and associated with a spring, wherein upon activation of the actuating unit the spring is release, changing the valve position through the disk motion to close position.

According to some embodiments of the present invention the detection unit further comprising the step of measuring seismic waves, detecting seismic waves which exceeds predefined level a signal is sent to the shut of unit for closing the valve.

According to some embodiments of the present invention the method further comprising the step of coordinating plurality of detection devices and relay closure instruction to the respective shutoff valve unit.

According to some embodiments of the present invention the method further comprising the step of coordinating plurality of detection devices and shutoff valve units, by sending closure instruction to at least one shutoff valve unit upon receiving closure instruction from at least on associated detection unit.

### BRIEF DESCRIPTION OF THE DRAWINGS

The present invention will be more readily understood from the detailed description of embodiments thereof made in conjunction with the accompanying drawings of which:

FIG. 1 is a block diagram illustrating the components of the leak detection system according to some embodiments of the invention;

FIG. 3 is a block diagram the detection unit according to some embodiments of the invention;

FIG. 4 is an illustration the flow leak detection process according to some embodiments of the invention;

FIG. 5 is an exploded view of the shutoff unit components according to some embodiments of the invention.

FIG. 6 is an illustration of the detection unit according to some embodiments of the invention.

### DETAILED DESCRIPTION

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

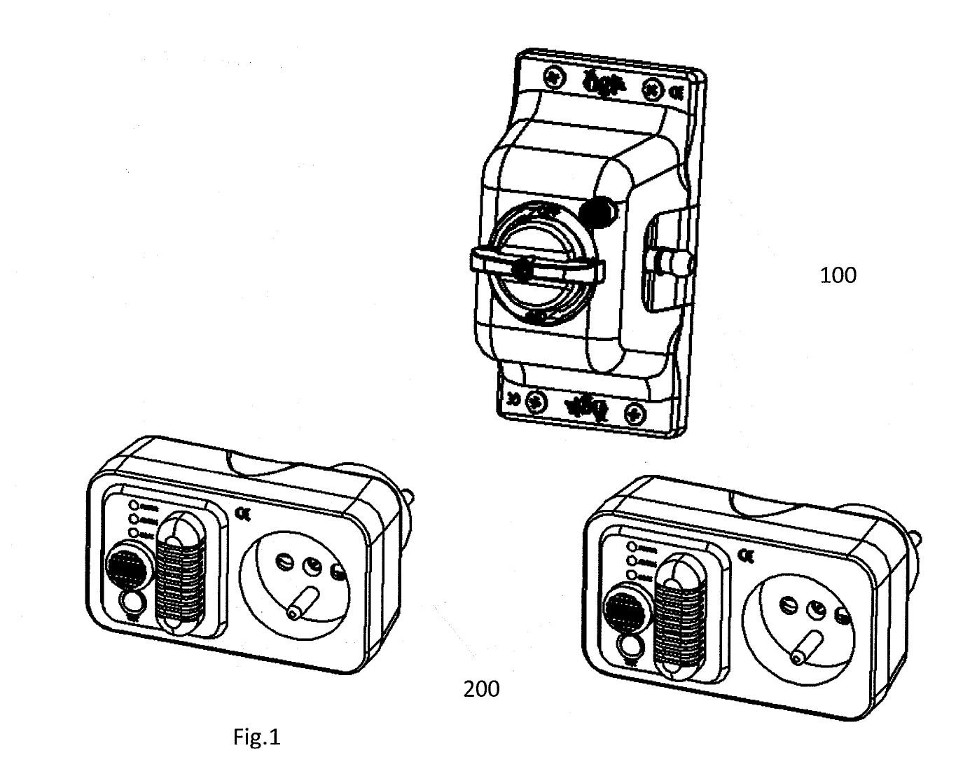

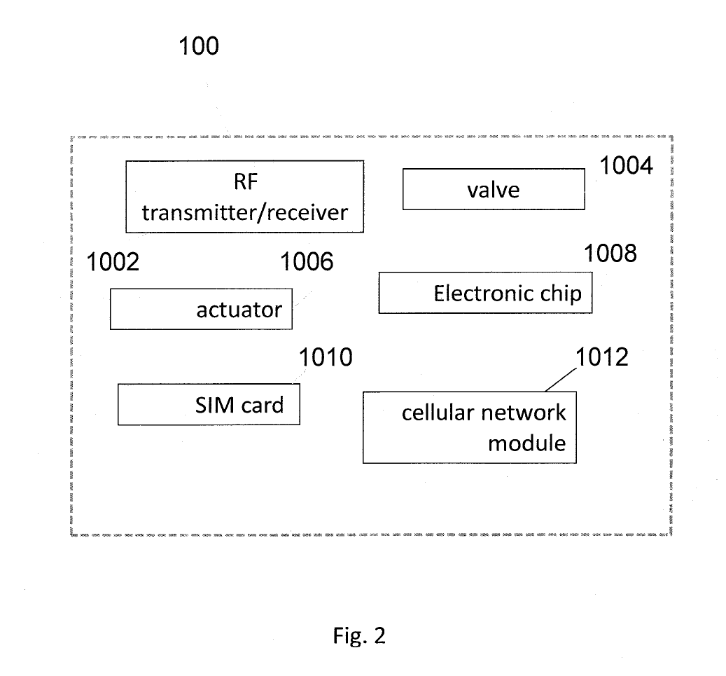

FIG. 1 illustrates the main components of the gas leak detection system implemented in pipe construction system according to some embodiments the present invention. The system includes, shutoff unit 100 positioned at an entrance point which includes a gas supply interface unit connected to inner wall of the building in which the pipe construction is installed and at least detection devices 200 positioned in the same space of the gas entrance point location. The shutoff valve communicates through wireless communication link with the detection devices 200 and the shutoff unit 100. The detection unit identifies odor related to the gas running within the pipe construction and transmits a signal through a wireless network to the shutoff gas unit. The shutoff unit is integrated with an existing entrance valve interface connected the inner wall surface of a building. According to some embodiments of the present invention, it is suggested to include more than one detection device in each space, each detection device is designed to identify different type of gas, such Co or Butane gas. Each detection unit may have different sensors and apply different tests to identify plurality of gas types. Some sensors may require only battery energy source and other may require to be connected to AC power supply.

FIG. 2 is a block diagram illustrating of the shutoff unit design according to some embodiments of the invention. The shutoff unit comprises a communication module 1002 such as an RF transmitter for communicating with the detection units, a valve unit 1004 for closing the entrance interface, actuator such as electromagnet unit 1006 for operating the valve and an electronic chip 1008 for operating the actuator. According to some embodiments of the present invention it is suggested to add cellular network module 1010 (Such as GSM module) and a SIM card 1012 for enabling reporting alerts of identified leaks to predefined users phone numbers associated to technical support of the pipe construction.

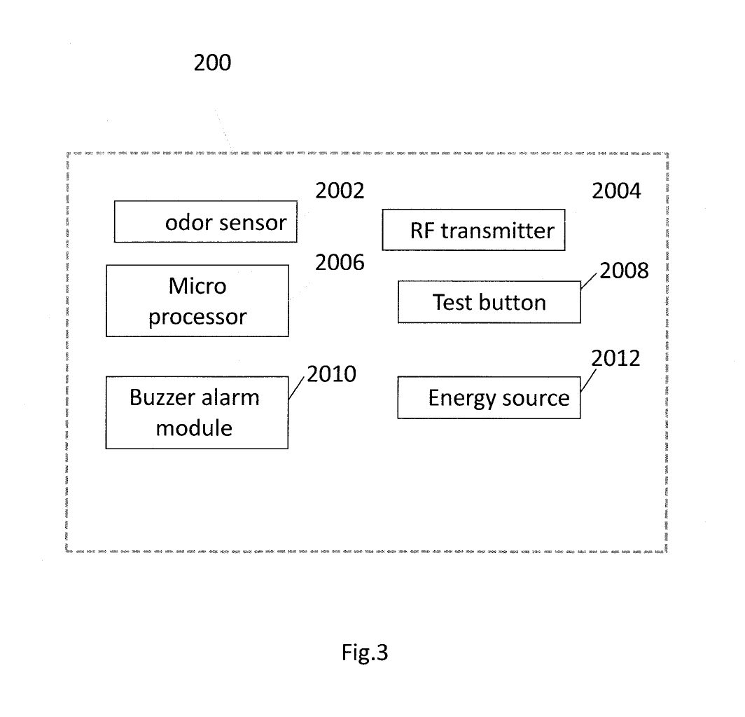

FIGS. 3 is a block diagram of the detection unit design according to some embodiments of the invention. The detection unit comprises an odor sensor 2002 for measuring odor presence, a transmitter unit 2004 for sending signal indicating of odor detection exceeding a predetermined level, a micro processor 2006 including an algorithm for determining gas level according to sensor measurements, test module 2008 enabling to test the sensor operation, buzzer alarm module 2010 enabling to activate sound alarm incase the gas concentration is the air has exceeded predefined level and an energy source such as battery or transformation for connecting AC power supply.

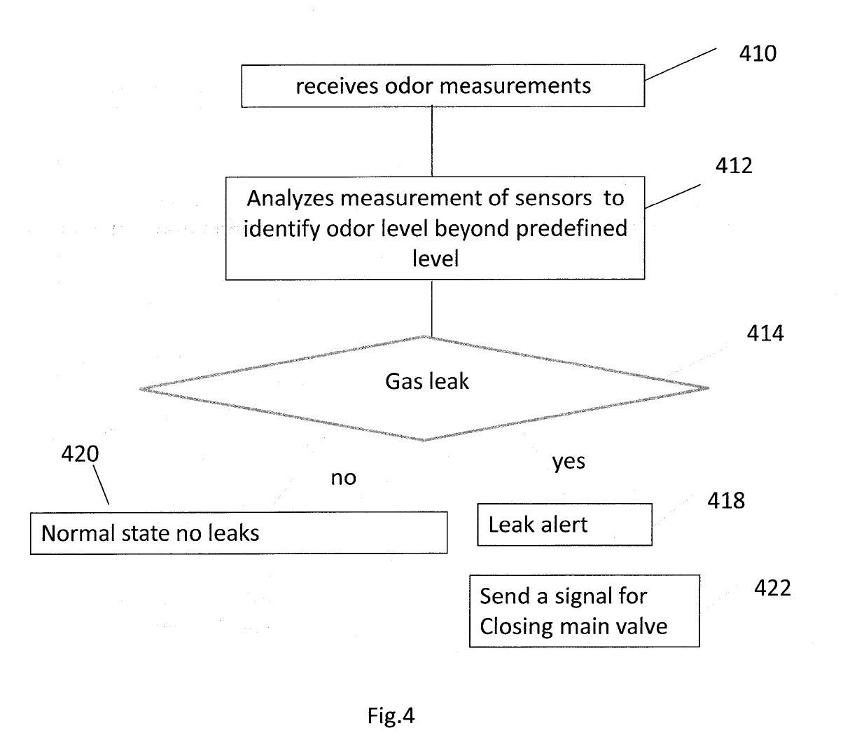

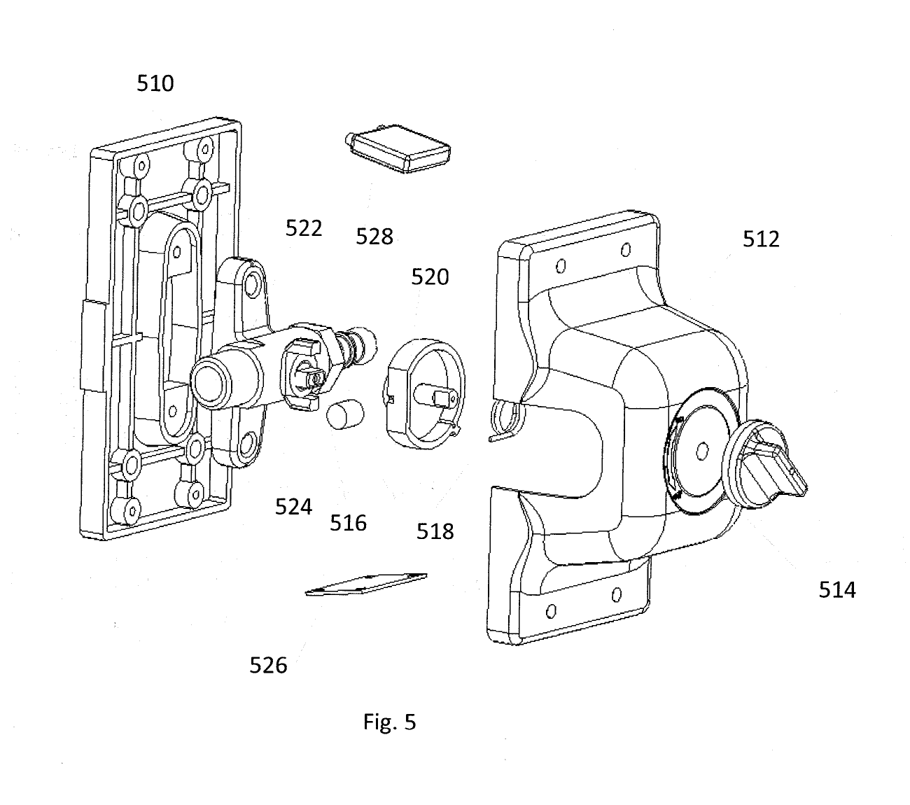

FIG. 4 is an illustration the flow leak detection process according to some embodiments of the invention. The detection units receives odor measurements (step 410) and analyzes data for identifying measurements which exceeds a predefined level (step 412). Based on this analysis, the detection unit determines if there is a gas leak. In case of positive detection, an alert message may be generated (step 418) and control signal is sent (step 422) to the shutoff unit entrance point for closing the valve, otherwise the normal state proceeds (step 420).

FIG. 5 is an exploded view of the shutoff unit components according to some embodiments of the invention. The shutoff unit is integrated with an existing entrance valve housing including: an enclosure base 510 and enclosure top 512. Within the housing are located: A valve 522 which is part of exiting entrance interface, a disk 520 which is associated with spring 518, an actuating unit 516, a PCB unit 516 and a battery 528. The actuating unit is controlled by the PCB unit 526, which receives the detection signals from the detection unit. Upon receiving a positive detection signal the PCB activates the actuator 516 to release the spring 518. Upon releasing, the valve changes position to close state. The valve can be controlled manually by the button 514.

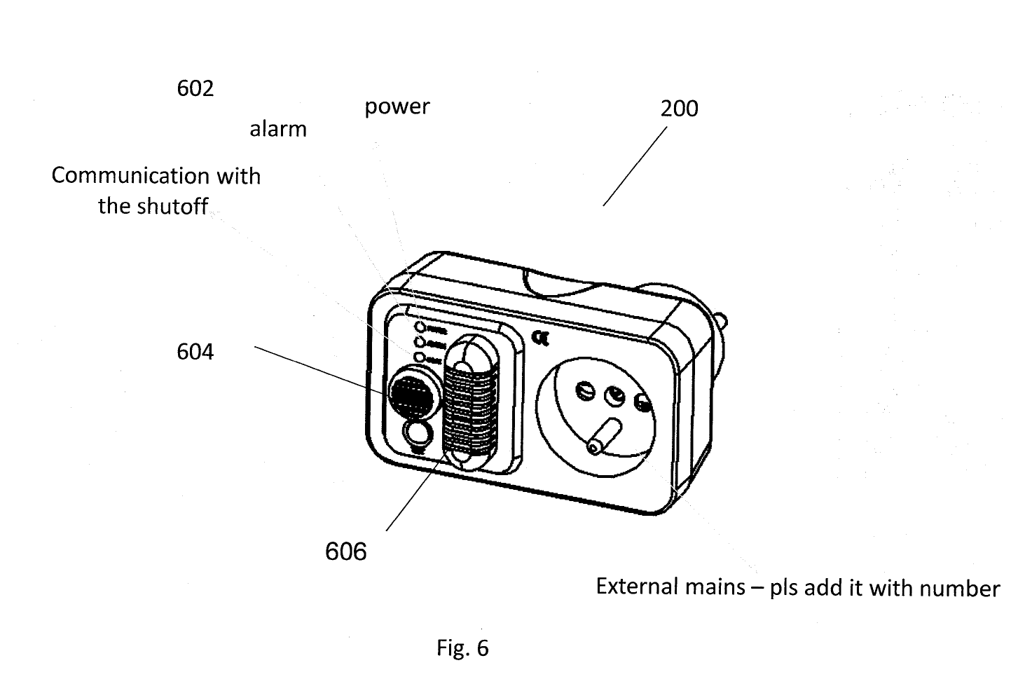

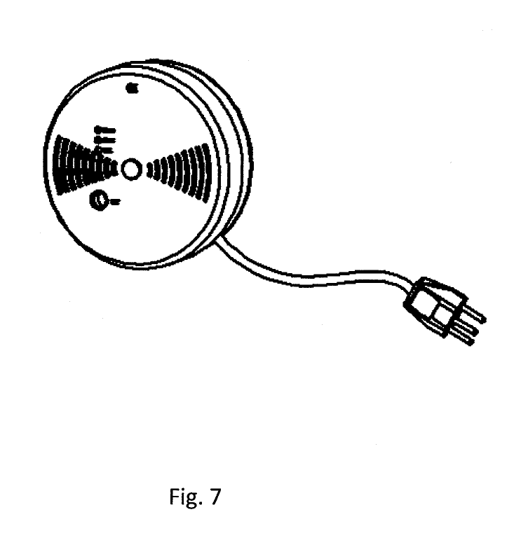

FIG. 6 is an illustration of the detection unit according to some embodiments of the invention. The detection unit may include a led indicator 602 for verifying activation of the unit, a buzzer button 604 for activating an alarm and odor sensor 606.

According to some embodiments of the present invention the system includes Seismometer detection unit for identifying seismic waves which indicate of earthquake. This detection located in the same space of the shutoff unit wherein upon detecting an earthquake, a signal is transmitted to the shutoff unit for closing the valve.

According to some embodiments of the present invention the system may include plurality of detection devices and operating unit for controlling the devices, installed in an industrial kitchen facility. Each detection device is positioned near by one at least one stove and transmits signals to the operating unit. The operating unit receives the signals indicating of a gas leak, from the different detection units and sends lock instruction to the corresponding shutoff unit. Industrial kitchen facility may include more than one shutoff unit, where the operating units coordinates the detection units signals, sending the lock instruction to relevant shutoff units. The operating units may further include communication units such as GSM, sending electronic messages such as SMS to relevant personal.

According to some embodiments of the present invention the operating unit may integrate the control of shutoff unit of two types, one type of gas shutoff unit as disclosed herein, and shutoff unit of water pipe construction. The operating unit will receive signals from gas leak detection units as described herein and from water leak detection unit. The water detection units may include acoustic sensors, located nearby the exit points and entrance point of the water pipe construction for detecting abnormal water leaks in the pipe construction. The operating unit according to this embodiment may include algorithm for each of type fluid for identifying leaks and sending closing instruction to the respective shutoff unit to close the corresponding valve.

Reference in the specification to “some embodiments”, “an embodiment”, “one embodiment” or “other embodiments” means that a particular feature, structure, or characteristic described in connection with the embodiments is included in at least, some embodiments, but not necessarily all embodiments, of the inventions.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not to be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

What is claimed is:

1. A system for identifying gas leaks in pipe construction, said system comprised of:
at least one gas detection unit comprising an odor sensor and a wireless communication unit, said detection unit is positioned in proximity of at least one gas entrance of said pipe construction;
at least one controlled shutoff unit comprising a valve an actuator unit and wireless communication unit, said shutoff unit integrated with interface entrance unit of the pipe construction, said actuator unit arranged to control the valve;
wherein upon detection of odor measurement exceeding predefined level a closing instruction is transmitted to a shutoff unit for activating the actuator unit to close the valve.

2. The system of claim 1 wherein the detection unit further comprises a micro processor which includes algorithm for determining gas level.

3. The system of claim 1 wherein the detection unit further comprises a test module for testing the sensor operation.

4. The system of claim 1 wherein the detection unit further comprises a buzzer alarm module enabling to activate sound alarm incase the gas concentration is the air has exceeded predefined level.

5. The system of claim 1 wherein the shutoff unit further comprises a PCB unit for receiving the detection signals from the detection unit and controlling the actuating unit.

6. The system of claim 1 wherein the shutoff unit further comprises a disk connected to the valve and associated with a spring, wherein upon activation of the actuating unit the spring is released, changing the valve position through the disk motion to close position.

7. The system of claim 1 wherein the valve can be controlled manually by a button.

8. The system of claim 1 wherein the system unit further comprises a Seismometer, wherein upon detecting seismic waves which exceeds predefined level a signal is sent to the shut of unit for closing the valve.

9. The system of claim 1 further comprising an operating unit for coordinating plurality of detection devices and relay closing instructions to the respective shutoff valve unit.

10. The system of claim 9 wherein the system includes plurality of shutoff valves and the operating unit coordinate the operations of the plurality of shutoff valve units.

11. The system of claim 10 wherein the system includes plurality of shutoff valves units of different types including gas shutoff unit and water shutoff unit and detection units for identifying gas leak and water leak, wherein the operating unit is programmed to receive instructions from the different detection units and send instruction for closing the respective valves by the corresponding shutoff unit.

12. A method for identifying gas leaks in pipe construction using a detection unit and shutoff unit, wherein the detection units include an odor sensor and the shutoff unit include an actuating unit and a valve, said method comprises the steps of:
measuring an odor in proximity of at least one gas entrance of said pipe construction by the odor sensor;
checking odor measurement level;
transmitting closing instruction to a shutoff unit in case the odor measurement exceeded predefined level;
activating the actuator unit upon receiving the closure instruction, wherein the actuating device action closes the valve.

13. The method of claim 12 further comprising the step of testing the sensor operation.

14. The method claim further comprising the step activating sound alarm incase the gas concentration is the air has exceeded predefined level.

15. The method of claim 12 wherein the shutoff unit further comprises a disk connected to the valve and associated with a spring, wherein upon activation of the actuating unit the spring is released, changing the valve position through the disk motion to close position.

16. The method of claim 12 wherein the detection unit further comprising the steps of measuring seismic waves, detecting seismic waves which exceeds predefined level and sending signal to the shut of unit for closing the valve.

17. The method of claim 12 further comprising the step of coordinating plurality of detection devices and relay closure instruction to the respective shutoff valve unit.

18. The method of claim 12 further comprising the step of coordinating plurality of detection devices and shutoff valve units, by sending closing instruction to at least one shutoff valve unit upon receiving closure instruction from at least on associated detection unit.
